(19) United States
(12) Patent Application Publication
(10) Pub. No.: US 2025/0038575 A1
(43) Pub. Date: Jan. 30, 2025

(54) WIRELESS POWER RECEIVING DEVICE

(71) Applicant: Murata Manufacturing Co., Ltd., Kyoto-fu (JP)

(72) Inventors: Koyo KAIWA, Nagaokakyo-shi (JP); Tatsuya HOSOTANI, Nagaokakyo-shi (JP)

(73) Assignee: Murata Manufacturing Co., Ltd., Kyoto-fu (JP)

(21) Appl. No.: 18/911,821

(22) Filed: Oct. 10, 2024

Related U.S. Application Data
(63) Continuation of application No. PCT/JP2023/015536, filed on Apr. 19, 2023.

(30) Foreign Application Priority Data
Apr. 21, 2022 (JP) 2022-069822

(51) Int. Cl. H02J 50/12; H01F 27/24; H01F 27/28; H01F 38/14; H01M 10/46; H02J 50/40; H04R 25/00

(52) U.S. Cl. CPC H02J 50/12; H01F 27/28; H01F 38/14; H01M 10/46; H02J 50/402; H01F 27/24; H04R 25/554

(57) ABSTRACT

A wireless power receiving device includes power receiving coils, power receiving resonance circuits, and rectifier circuits. The power receiving coils each generate a power receiving current by being coupled to an external magnetic field. Each power receiving resonance circuit includes a power receiving coil and a capacitor. The rectifier circuits are connected to the power receiving resonance circuits and rectify resonance currents, respectively. The power receiving coils are planar spiral coils, and the power receiving coils are cylindrical solenoid coils. The power receiving coils and the power receiving coils are disposed in a state where a direction orthogonal to a plane of the spiral coil and axes of cylindrical shapes of the solenoid coils are not parallel to each other. A power adding circuit adds DC outputs of the rectifier circuits at a subsequent stage of the rectifier circuits and supplies power to a load.

### CROSS-REFERENCE TO RELATED APPLICATIONS

This application claims benefit of priority to International Patent Application No. PCT/JP2023/015536, filed Apr. 19, 2023, and to Japanese Patent Application No. 2022-069822, filed Apr. 21, 2022, the entire contents of each are incorporated herein by reference.

### BACKGROUND

### Technical Field

The present disclosure relates to a wireless power receiving device including a power receiving coil in a housing having a complicated shape.

### Background Art

Japanese Unexamined Patent Application Publication No. 2019-40860 describes a hearing aid including a housing formed in a shape of an auricle and a coil member disposed in the housing.

In the hearing aid described in Japanese Unexamined Patent Application Publication No. 2019-40860, two coil members are used. The two coil members are planar coils and are disposed in parallel to each other.

### SUMMARY

However, in the configuration described in Japanese Unexamined Patent Application Publication No. 2019-40860, power cannot be efficiently received, unless the hearing aid is disposed in specific posture with respect to a power transmission stand (power transmission coil).

In particular, in a case of a device having a housing with a complicated three-dimensional shape, such as the hearing aid, the device is not always disposed in the same posture on a power transmission stand, and there are cases where power cannot be received or power receiving efficiency is significantly reduced.

Thus, the present disclosure provides a wireless power receiving device for which a decrease in power receiving efficiency due to disposition posture on a power transmission stand (power transmission coil) can be suppressed.

A wireless power receiving device of the present disclosure includes a first power receiving coil, a second power receiving coil, a load, a first power receiving resonance circuit, a second power receiving resonance circuit, a first rectifier circuit, and a second rectifier circuit. The first power receiving coil and the second power receiving coil are each configured to generate a power receiving current by being coupled to an external magnetic field. The load is configured to be driven by power based on the power receiving current. The first power receiving resonance circuit is configured to include the first power receiving coil and a first resonance capacitor, and the second power receiving resonance circuit is configured to include the second power receiving coil and a second resonance capacitor. The first rectifier circuit is connected to the first power receiving resonance circuit and configured to rectify a resonance current from the first power receiving resonance circuit and supply power to the load. The second rectifier circuit is connected to the second power receiving resonance circuit and configured to rectify a resonance current from the second power receiving resonance circuit and supply power to the load.

The first power receiving coil is a spiral coil of a planar shape, and the second power receiving coil is a solenoid coil of a cylindrical shape. The first power receiving coil and the second power receiving coil are disposed in a state where a direction orthogonal to a plane of the spiral coil and an axis of the cylindrical shape of the solenoid coil are not parallel to each other. A power adding circuit is provided at a subsequent stage of each of the first rectifier circuit and the second rectifier circuit, adds a DC output of the first rectifier circuit and a DC output of the second rectifier circuit, and supplies power to the load.

In this configuration, the first power receiving coil and the second power receiving coil can be appropriately disposed according to a shape of a housing of the wireless power receiving device. Even when magnetic fluxes interlink with the housing in a plurality of different directions, either the first power receiving coil or the second power receiving coil can efficiently receive power. Then, the DC output obtained from the first power receiving coil and the DC output obtained from the second power receiving coil are added and supplied to the load, and thus efficient power receiving is possible regardless of posture of the wireless power receiving device.

According to the present disclosure, it is possible to efficiently receive power by increasing a degree of freedom in disposing a power receiving device regardless of disposition posture of a wireless power receiving device on a power transmission stand (power transmission coil). It is also possible to achieve a small power receiving device having excellent power receiving performance by effectively utilizing each of a planar spatial region and a cylindrical spatial region even in a housing having a complicated three-dimensional shape.

### BRIEF DESCRIPTION OF THE DRAWINGS

FIG. 1 is a circuit diagram of a wireless power receiving device according to an embodiment of the present disclosure;

FIG. 2A, FIG. 2B, FIG. 2C, and FIG. 2D are diagrams illustrating a schematic structure of the wireless power receiving device according to the embodiment of the present disclosure;

FIG. 3 is an external perspective view of the wireless power receiving device according to the embodiment of the present disclosure;

FIG. 4A is a plan view illustrating an example of a planar spiral coil, and FIG. 4B is a sectional view taken along line E-E in FIG. 4A;

FIG. 5A is a side view of a solenoid coil, and FIG. 5B is an end view of the solenoid coil;

FIG. 6A, FIG. 6B, and FIG. 6C are diagrams each illustrating a case where power is supplied with the wireless power receiving device placed on a power supply stand; and

FIG. 7A and FIG. 7B are diagrams illustrating a schematic structure of a wireless power receiving device according to a derived example of the embodiment of the present disclosure.

### DETAILED DESCRIPTION

A wireless power receiving device according to an embodiment of the present disclosure will be described with reference to the drawings.

### (Circuit Configuration of Wireless Power Receiving Device 10)

### (Connection Configuration)

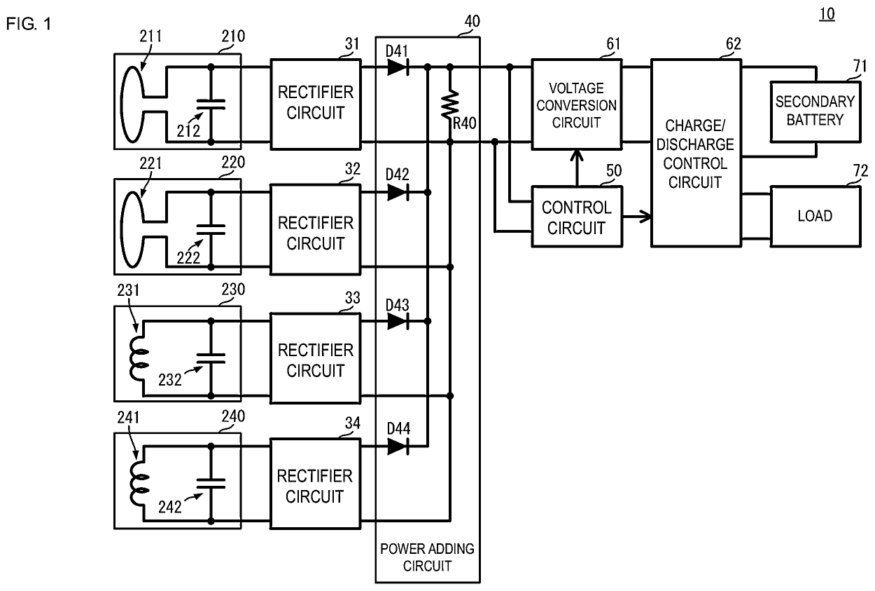

FIG. 1 is a circuit diagram of the wireless power receiving device according to the embodiment of the present disclosure.

As illustrated in FIG. 1, a wireless power receiving device 10 includes a power receiving coil 211, a power receiving coil 221, a power receiving coil 231, a power receiving coil 241, a capacitor 212, a capacitor 222, a capacitor 232, and a capacitor 242.

Further, the wireless power receiving device 10 includes a rectifier circuit 31, a rectifier circuit 32, a rectifier circuit 33, a rectifier circuit 34, a power adding circuit 40, a control circuit 50, a voltage conversion circuit 61, a charge/discharge control circuit 62, a secondary battery 71, and a load 72.

The capacitor 212 is connected in parallel to the power receiving coil 211. A parallel circuit of the power receiving coil 211 and the capacitor 212 constitutes a power receiving resonance circuit 210. The capacitor 222 is connected in parallel to the power receiving coil 221. A parallel circuit of the power receiving coil 221 and the capacitor 222 constitutes a power receiving resonance circuit 220.

The capacitor 232 is connected in parallel to the power receiving coil 231. A parallel circuit of the power receiving coil 231 and the capacitor 232 constitutes a power receiving resonance circuit 230. The capacitor 242 is connected in parallel to the power receiving coil 241. A parallel circuit of the power receiving coil 241 and the capacitor 242 constitutes a power receiving resonance circuit 240.

The power receiving coil 211 and the power receiving coil 221 correspond to a “first power receiving coil” of the present disclosure, and the power receiving coil 231 and the power receiving coil 241 correspond to a “second power receiving coil” of the present disclosure. The capacitor 212 and the capacitor 222 correspond to a “first resonance capacitor” of the present disclosure, and the capacitor 232 and the capacitor 242 correspond to a “second resonance capacitor” of the present disclosure. The power receiving resonance circuit 210 and the power receiving resonance circuit 220 correspond to a “first power receiving resonance circuit” of the present disclosure, and the power receiving resonance circuit 230 and the power receiving resonance circuit 240 correspond to a “second power receiving resonance circuit” of the present disclosure.

An output terminal of the power receiving resonance circuit 210 is connected to an input terminal of the rectifier circuit 31, and an output terminal of the power receiving resonance circuit 220 is connected to an input terminal of the rectifier circuit 32. An output terminal of the power receiving resonance circuit 230 is connected to an input terminal of the rectifier circuit 33, and an output terminal of the power receiving resonance circuit 240 is connected to an input terminal of the rectifier circuit 34. The rectifier circuit 31 and the rectifier circuit 32 correspond to a “first rectifier circuit” of the present disclosure, and the rectifier circuit 33 and the rectifier circuit 34 correspond to a “second rectifier circuit” of the present disclosure.

An output terminal of the rectifier circuit 31, an output terminal of the rectifier circuit 32, an output terminal of the rectifier circuit 33, and an output terminal of the rectifier circuit 34 are connected to the power adding circuit 40.

An output terminal of the power adding circuit 40 is connected to an input terminal of the control circuit 50 and an input terminal of the voltage conversion circuit 61. An output terminal of the voltage conversion circuit 61 is connected to an input terminal of the charge/discharge control circuit 62. An output terminal of the charge/discharge control circuit 62 is connected to the secondary battery 71 and the load 72.

The secondary battery 71 is, for example, a thin battery. Accordingly, it is easy to accommodate the secondary battery 71 in a housing 100 described later, and an increase in size of the housing 100 can be suppressed.

The load 72 is a circuit or the like that performs a function of a device achieved with the wireless power receiving device 10, and is configured by a microphone, an amplification circuit of an audio signal, and the like, for example, when the wireless power receiving device 10 is a hearing aid.

### (Operation of Wireless Power Receiving Device 10)

The power receiving coil 211, the power receiving coil 221, the power receiving coil 231, and the power receiving coil 241 each generate a power receiving current by being coupled to an external magnetic field. More specifically, when a device in which the wireless power receiving device 10 is mounted is placed on a power supply stand, the power receiving coil 211, the power receiving coil 221, the power receiving coil 231, and the power receiving coil 241 are coupled to an alternating magnetic field generated by a current flowing through a power supply coil of the power supply stand and each generate a power receiving current. At this time, the power receiving currents respectively generated by the power receiving coil 211, the power receiving coil 221, the power receiving coil 231, and the power receiving coil 241 are different in magnitude depending on placement posture of the device with respect to the power supply stand.

At this time, resonance frequencies of the power receiving resonance circuit 210, the power receiving resonance circuit 220, the power receiving resonance circuit 230, and the power receiving resonance circuit 240 are matched with a frequency of the alternating magnetic field (in other words, a drive frequency for generating a power supply current of a power supply device). Thus, an electromagnetic resonance field is formed between the power supply coil and power receiving coils coupled to the alternating magnetic field among the power receiving coil 211, the power receiving coil 221, the power receiving coil 231, and the power receiving coil 241. As a result, low-loss power receiving is enabled. Note that the frequency of the alternating magnetic field is, for example, 6.78 MHz or 13.56 MHz. Accordingly, an ISM band can be used for wireless power supply.

From the power receiving resonance circuit 210, a resonance current based on the power receiving current by the power receiving coil 211 is outputted. From the power receiving resonance circuit 220, a resonance current based on the power receiving current by the power receiving coil 221 is outputted. From the power receiving resonance circuit 230, a resonance current based on the power receiving current by the power receiving coil 231 is outputted. From the power receiving resonance circuit 240, a resonance current based on the power receiving current by the power receiving coil 241 is outputted.

The rectifier circuit 31 rectifies the resonance current from the power receiving resonance circuit 210 and outputs a first direct current. The rectifier circuit 32 rectifies the resonance current from the power receiving resonance circuit 220 and outputs a second direct current. The rectifier circuit 33 rectifies the resonance current from the power receiving resonance circuit 230 and outputs a third direct current. The rectifier circuit 34 rectifies the resonance current from the power receiving resonance circuit 240 and outputs the fourth direct current.

The power adding circuit 40 is configured by an OR circuit. The power adding circuit 40 adds the first direct current, the second direct current, the third direct current, and the fourth direct current and outputs added and combined currents. DC power due to the added and combined currents is supplied to the secondary battery 71 and the load 72 through the voltage conversion circuit 61 and the like.

As a more specific circuit configuration, the power adding circuit 40 includes a diode D41, a diode D42, a diode D43, a diode D44, and a resistor R40. An anode of the diode D41 is connected to a Hi-side output terminal of the rectifier circuit 31. An anode of the diode D42 is connected to a Hi-side output terminal of the rectifier circuit 32. An anode of the diode D43 is connected to a Hi-side output terminal of the rectifier circuit 33. An anode of the diode D44 is connected to a Hi-side output terminal of the rectifier circuit 34. A cathode of the diode D41, a cathode of the diode D42, a cathode of the diode D43, and a cathode of the diode D44 are connected to each other and are connected to a Hi-side output terminal of the power adding circuit 40. The resistor R40 is connected between the Hi-side output terminal and a low-side output terminal of the power adding circuit 40.

The control circuit 50 is driven by receiving output power from the power adding circuit 40 and performs operation control of the voltage conversion circuit 61 and the charge/discharge control circuit 62.

Under the control of the control circuit 50, the voltage conversion circuit 61 converts an input voltage from the power adding circuit 40 into a predetermined voltage value and outputs the voltage value to the charge/discharge control circuit 62. Under the control of the control circuit 50, the charge/discharge control circuit 62 outputs a charging current for charging the secondary battery 71 by power supplied from the voltage conversion circuit 61. Further, the charge/discharge control circuit 62 outputs a current inputted from the secondary battery 71 to the load 72. That is, power is supplied from the secondary battery 71 to the load 72. Note that although the aspect including the charge/discharge control circuit 62, the secondary battery 71, and the load 72 separately has been illustrated here, the charge/discharge control circuit 62 and the secondary battery 71 may be included as a part of the load 72.

### (Structure of Wireless Power Receiving Device 10)

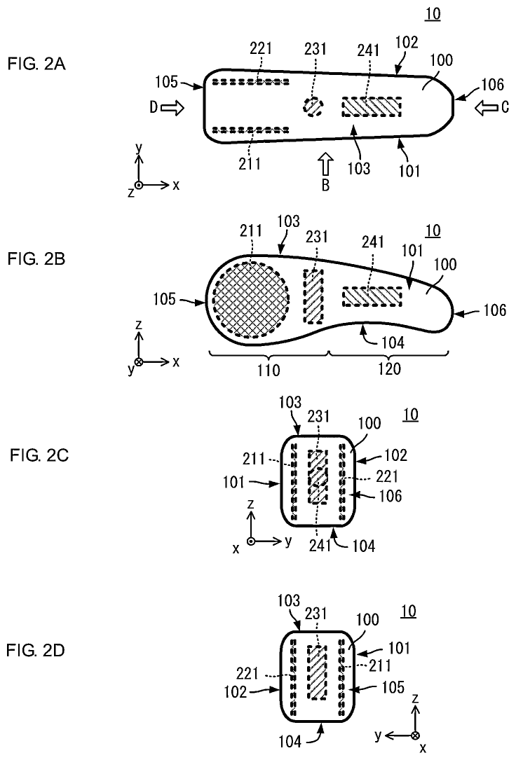

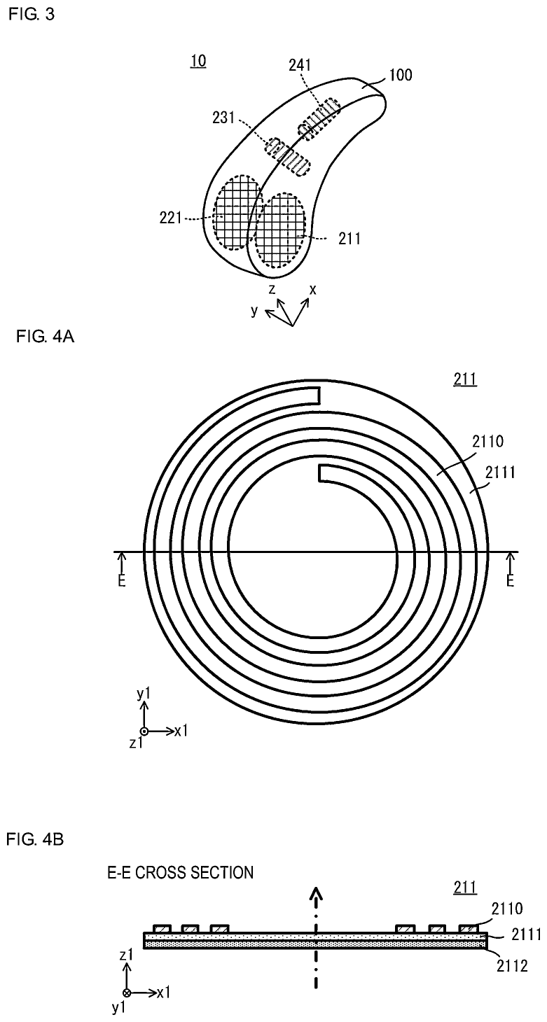

FIG. 2A, FIG. 2B, FIG. 2C, and FIG. 2D are diagrams illustrating a schematic structure of the wireless power receiving device according to the embodiment of the present disclosure. FIG. 2A, FIG. 2B, FIG. 2C, and FIG. 2D are diagrams of the wireless power receiving device viewed from respective different directions. FIG. 3 is an external perspective view of the wireless power receiving device according to the embodiment of the present disclosure. Note that in the following description, an x-axis direction, a y-axis direction, and a z-axis direction are used for describing a shape in an easily understandable manner, but an x-axis, a y-axis, and a z-axis only mean three axes orthogonal to each other.

As illustrated in FIG. 2A, FIG. 2B, FIG. 2C, FIG. 2D, and FIG. 3, the wireless power receiving device 10 includes the housing 100. The housing 100 includes a surface 101, a surface 102, a surface 103, a surface 104, a surface 105, and a surface 106. Note that the housing 100 of the wireless power receiving device 10 has a shape matched with a shape of an auricle, but the shape will be described below focusing on points related to the disclosure.

The surface 101 and the surface 102 are surfaces substantially parallel to the x-axis direction and the z-axis direction and are separated by a predetermined distance in the y-axis direction. The surface 101 and the surface 102 are substantially parallel to each other and face each other. The surface 103 is connected to an edge at one end in the z-axis direction of each of the surface 101 and the surface 102. The surface 104 is connected to an edge at another end in the z-axis direction of each of the surface 101 and the surface 102. The surface 105 is connected to an edge at one end in the x-axis direction of each of the surface 101 and the surface 102. The surface 106 is connected to an edge at another end in the x-axis direction of each of the surface 101 and the surface 102.

Here, in each of the surface 101 and the surface 102, a length in the z-axis direction on one end side in the x-axis direction is larger than a length in the z-axis direction on another end side in the x-axis direction. That is, in each of the surface 101 and the surface 102, a region 110 on a side connected to the surface 105 is wider than a region 120 on a side connected to the surface 106.

Each circuit element for achieving the above-described circuit configuration is incorporated in the housing 100 having the above-described shape. Schematically, these circuit elements are mounted on a circuit board, and the circuit board on which these circuit elements are mounted is incorporated in the housing 100. The circuit board may be a solid board or a flexible board.

### (Structure of Power Receiving Coil)

In the above-described configuration, the power receiving coil 211, the power receiving coil 221, the power receiving coil 231, and the power receiving coil 241 have the following shapes and are disposed in the housing 100 in the following manner.

The power receiving coil 211 and the power receiving coil 221 are planar spiral coils. FIG. 4A is a plan view illustrating an example of the planar spiral coil, and FIG. 4B is a sectional view taken along line E-E in FIG. 4A. Note that although FIG. 4A and FIG. 4B illustrate the power receiving coil 211 as an example, the power receiving coil 221 has a similar structure.

The power receiving coil 211 includes a wound linear conductor 2110, an insulating support film 2111, and a magnetic sheet 2112. The linear conductor 2110 is formed on a first surface of the insulating support film 2111. The magnetic sheet 2112 is disposed on a second surface of the insulating support film 2111. The magnetic sheet 2112 is disposed such that the linear conductor 2110 and the magnetic sheet 2112 are parallel to each other.

With such a configuration, the power receiving coil 211 is coupled to a magnetic flux in a direction orthogonal to a plane on which the linear conductor 2110 is formed with a high degree of coupling.

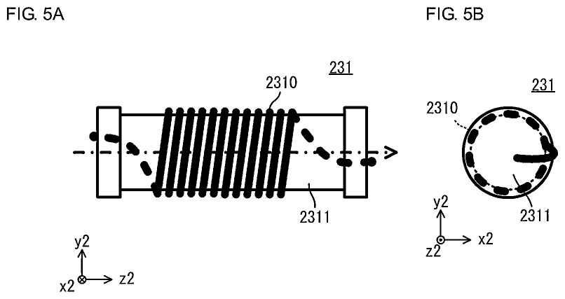

The power receiving coil 231 and the power receiving coil 241 are cylindrical (for example, circular cylindrical) solenoid coils. FIG. 5A is a side view of the solenoid coil, and FIG. 5B is an end view of the solenoid coil. Note that although FIG. 5A and FIG. 5B illustrate the power receiving coil 231 as an example, the power receiving coil 241 has a similar structure.

The power receiving coil 231 includes a cylindrical and spiral linear conductor 2310 and a columnar magnetic core 2311. The magnetic core 2311 is disposed in a space inside a spiral of the linear conductor 2310.

With such a configuration, the power receiving coil 231 is coupled to a magnetic flux in an axial direction of the spiral with a high degree of coupling.

### (Disposition Aspect of Each Power Receiving Coil in Housing)

As illustrated in FIG. 2A, FIG. 2B, FIG. 2C, FIG. 2D, and FIG. 3, the power receiving coil 211 is disposed at a position close to the surface 101 inside the housing 100. At this time, the power receiving coil 211 is disposed such that the plane formed by the wound linear conductor 2110 is substantially parallel to the surface 101 (such that the x-axis of the housing 100 is substantially parallel to an x1-axis of the power receiving coil 211). Further, the power receiving coil 211 is disposed in the housing 100 such that the linear conductor 2110 is disposed closer to the surface 101 side than the magnetic sheet 2112 is.

The power receiving coil 221 is disposed at a position close to the surface 102 inside the housing 100. At this time, the power receiving coil 221 is disposed such that a plane formed by a wound linear conductor is substantially parallel to the surface 102 (such that the x-axis of the housing 100 is substantially parallel to the x1-axis of the power receiving coil 221). Further, the power receiving coil 221 is disposed in the housing 100 such that the linear conductor is disposed closer to the surface 102 side than the magnetic sheet is.

The power receiving coil 211 and the power receiving coil 221 are disposed in the region 110 in the housing 100. Thus, even when the housing 100 is small, the power receiving coil 211 and the power receiving coil 221 are each disposed at a portion with a large area in the housing 100. Thus, a planar area of each of the power receiving coil 211 and the power receiving coil 221 can be increased, and the power receiving current can be increased.

The power receiving coil 231 is disposed in the housing 100 such that an axial direction (z2-axis direction) of the spiral linear conductor 2310 is parallel to the z-axis direction (a direction in which the surface 103 and the surface 104 are disposed at a distance) of the housing 100.

At this time, the power receiving coil 231 is disposed in the region 110 in the housing 100. In the region 110, a distance between the surface 103 and the surface 104 is long. Thus, the power receiving coil 231 in which a length in the axial direction (z2-axial direction) is larger than lengths in other directions (the x2-axial direction and a y2-axial direction) can be disposed between the surface 103 and the surface 104, that is, in the housing 100.

The power receiving coil 241 is disposed in the housing 100 such that an axial direction (the z2-axis direction) of a spiral linear conductor is parallel to the x-axis direction (a direction in which the surface 105 and the surface 106 are disposed at a distance) of the housing 100.

At this time, the power receiving coil 241 is disposed in the region 120 in the housing 100. In the region 120, a distance between the surface 103 and the surface 104 is short, but a distance in the direction in which the surface 105 and the surface 106 are disposed at a distance is long. Thus, the power receiving coil 241 in which a length in the axial direction (z2-axial direction) is larger than lengths in other directions (the x2-axial direction and the y2-axial direction) can be disposed between the surface 105 and the surface 106, that is, in the housing 100. Further, disposition at a position not overlapping the power receiving coil 231 and the power receiving coils 211 and 221 in the x-axis direction of the housing 100 is possible.

According to such a disposition aspect, disposition in the housing 100 is made in a state where the direction orthogonal to the planes of the planar spiral coils (the power receiving coil 211 and the power receiving coil 221) and the axial directions of the solenoid coils (the power receiving coil 231 and the power receiving coil 241) are not parallel to each other.

With this configuration, the power receiving coil 211 and the power receiving coil 221 are coupled to a magnetic flux parallel to the y-axis direction of the housing 100 with a high degree of coupling. The power receiving coil 231 is coupled to a magnetic flux parallel to the z-axis direction of the housing 100 with a high coupling degree. The power receiving coil 241 is coupled to a magnetic flux parallel to the x-axis direction of the housing 100 with a high coupling degree. That is, the planar spiral coils (the power receiving coil 211 and the power receiving coil 221) are coupled to the magnetic flux parallel to the y-axis direction with a high coupling degree, and the solenoid coils (the power receiving coil 241 and the power receiving coil 231) are coupled to the magnetic fluxes parallel to the x-axis direction and the z-axis direction, respectively, with a high coupling degree.

As a result, in the wireless power receiving device 10, one power receiving coil among the power receiving coil 211, the power receiving coil 221, the power receiving coil 231, and the power receiving coil 241 is coupled to a magnetic flux in any direction with a high coupling degree.

Then, by appropriately disposing the planar spiral coils (the power receiving coil 211 and the power receiving coil 221) and the solenoid coils (the power receiving coil 231 and the power receiving coil 241) having respective different shapes in accordance with the shape of the housing 100, in the wireless power receiving device 10, these power receiving coils can be incorporated in the housing 100 even when the housing 100 is small.

### (Mounting Aspect on Power Supply Stand 190 and Power Receiving Aspect)

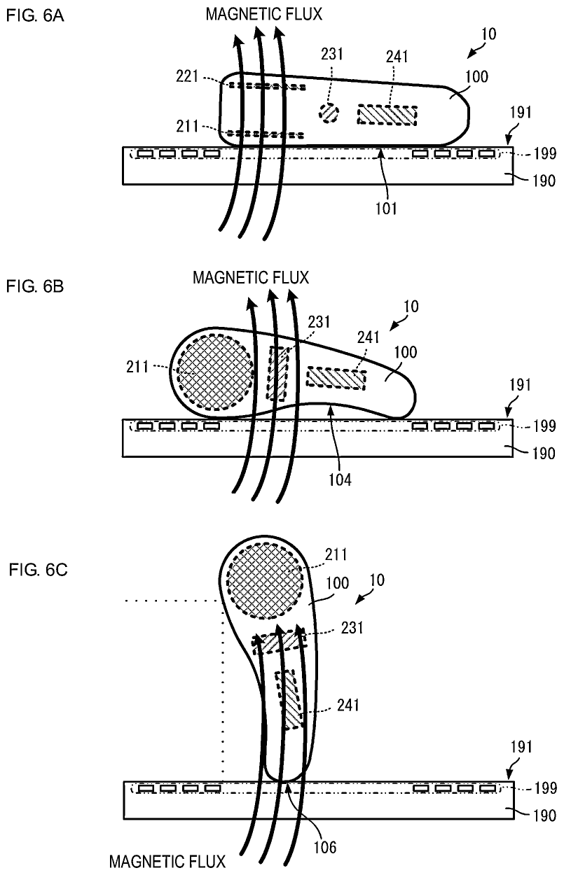

FIG. 6A, FIG. 6B, and FIG. 6C are diagrams each illustrating a case where power is supplied with the wireless power receiving device placed on a power supply stand.

As illustrated in FIG. 6A, FIG. 6B, and FIG. 6C, the wireless power receiving device 10 is placed on the power supply stand 190, and thus is supplied with power. The power supply stand 190 has a power supply surface 191. A power supply coil 199 is a planar spiral coil. The power supply coil 199 is disposed in a vicinity of the power supply surface 191, and is disposed parallel to the power supply surface 191. Thus, a magnetic flux generated by a current flowing through the power supply coil 199 is in a direction substantially orthogonal to the power supply surface 191 in the vicinity of the power supply surface 191.

In the case of FIG. 6A, the wireless power receiving device 10 is placed on the power supply surface 191 of the power supply stand 190 such that the surface 101 is close to (or abuts on) the power supply surface 191. In this case, the magnetic flux is in the direction orthogonal to the plane of the power receiving coil 211, and the power receiving coil 211 is coupled to the magnetic flux with a high degree of coupling. Thus, a high power receiving current is outputted from the power receiving coil 211.

Note that although not illustrated, when the surface 102 is close to the power supply surface 191, the power receiving coil 221 is coupled to the magnetic flux with a high degree of coupling, and a high power receiving current is outputted from the power receiving coil 221.

In the case of FIG. 6B, the wireless power receiving device 10 is placed on the power supply surface 191 of the power supply stand 190 such that the surface 104 is close to (or abuts on) the power supply surface 191. In this case, the magnetic flux is substantially parallel to the axial direction of the power receiving coil 231, and the power receiving coil 231 is coupled to the magnetic flux with a high degree of coupling. Thus, a high power receiving current is outputted from the power receiving coil 231.

Note that although not illustrated, when the surface 103 is close to the power supply surface 191 as well, the power receiving coil 231 is coupled to the magnetic flux with a high degree of coupling, and a high power receiving current is outputted from the power receiving coil 231.

In the case of FIG. 6C, the wireless power receiving device 10 is placed on the power supply surface 191 of the power supply stand 190 such that the surface 106 is close to (or abuts on) the power supply surface 191. In this case, the magnetic flux is substantially parallel to the axial direction of the power receiving coil 241, and the power receiving coil 241 is coupled to the magnetic flux with a high degree of coupling. Thus, a high power receiving current is outputted from the power receiving coil 241.

Note that although not illustrated, when the surface 105 is close to the power supply surface 191 as well, the power receiving coil 241 is coupled to the magnetic flux with a high degree of coupling, and a high power receiving current is outputted from the power receiving coil 241.

As described above, in the wireless power receiving device 10, one of the power receiving coil 211, the power receiving coil 221, the power receiving coil 231, and the power receiving coil 241 is coupled to the magnetic flux generated by the current of the power supply coil 199 with a high coupling degree in accordance with the placement state on the power supply stand 190, and can output a high power receiving current.

Then, the wireless power receiving device 10 can convert respective output currents of the power receiving coil 211, the power receiving coil 221, the power receiving coil 231, and the power receiving coil 241 into direct currents, add the direct currents, and supply the direct currents to the secondary battery 71 and the load 72. Thus, the wireless power receiving device 10 can efficiently receive power and supply power to the secondary battery 71 and the load 72, regardless of disposition posture on the power supply stand 190 (power supply coil 199).

### Derived Example

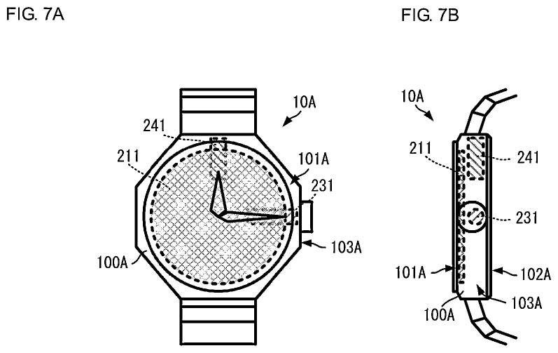

In the above-described description, the case has been illustrated in which the device applied as the wireless power receiving device 10 is the hearing aid, but the wireless power receiving device 10 can be applied to other devices. FIG. 7A and FIG. 7B are diagrams illustrating a schematic structure of a wireless power receiving device according to a derived example of the embodiment of the present disclosure. FIG. 7A and FIG. 7B are diagrams of the wireless power receiving device viewed from respective different directions.

As illustrated in FIG. 7A and FIG. 7B, a device to which a wireless power receiving device 10A is applied is a wristwatch. The wireless power receiving device 10A includes a housing 100A. The housing 100A includes a front surface 101A, a back surface 102A and a side surface 103A. The front surface 101A has an area that allows a dial plate or the like to be disposed. The back surface 102A is disposed in parallel to the front surface 101A and at a position facing the front surface 101A at a predetermined distance. The side surface 103A is orthogonal to the front surface 101A and the back surface 102A, and is connected to outer peripheries of the front surface 101A and the back surface 102A.

The housing 100A has a shape in which a thickness is small (the side surface 103A is low) and the front surface 101A has a large area.

The power receiving coil 211, the power receiving coil 231 and the power receiving coil 241 are disposed inside the housing 100A.

The power receiving coil 211 is disposed in the housing 100A such that the plane of the power receiving coil 211 is substantially parallel to the front surface 101A. With this configuration, an area of the power receiving coil 211 can be increased.

The power receiving coil 231 and the power receiving coil 241 are disposed in the housing 100A such that the respective axial directions thereof are parallel to the front surface 101A. With this configuration, even when the housing 100A is thin, the power receiving coil 231 and the power receiving coil 241 can be disposed.

Then, in this configuration, the direction orthogonal to the plane of the power receiving coil 211 formed of the planar spiral coil, the axial direction of the power receiving coil 231 formed of the cylindrical solenoid coil, and the axial direction of the power receiving coil 241 formed of the cylindrical solenoid coil are orthogonal to each other.

Thus, in the wireless power receiving device 10A, a decrease in power receiving efficiency due to disposition posture on a power supply stand (power supply coil) can be suppressed, as in the wireless power receiving device 10. In this case, as described above, each of the power receiving coils 211, 231, and 241 is appropriately disposed in accordance with the shape of the housing 100A of the wireless power receiving device 10A, and thus the housing 100A of the wireless power receiving device 10A can be reduced in size without reducing the power receiving efficiency.

Note that in the above-described embodiment, the aspect has been illustrated in which at least one of the planar spiral coil and the cylindrical solenoid coil includes a plurality of coils, but each of the number of planar spiral coils and the number of cylindrical solenoid coils may be one. However, when both the planar spiral coil and the cylindrical solenoid coil are included and three or more coils are provided in total, the coils can be coupled to a magnetic flux along any of the three orthogonal axes with a high coupling degree, which is more preferable.

In addition, in the above-described embodiment, the aspect has been illustrated in which the direction orthogonal to the plane of the planar spiral coil is orthogonal to the axial direction of the cylindrical solenoid coil. However, it is sufficient that the direction orthogonal to the plane of the planar spiral coil and the axial direction of the cylindrical solenoid coil are in a non-parallel state. In this case, it is sufficient that a disposition aspect of the planar spiral coil and the cylindrical solenoid coil is determined according to a shape of a housing, and a plurality of conceivable placement aspects on a power supply stand.

In addition, in the above-described embodiment, the hearing aid and the wristwatch are described as examples, but the shape of the housing of the wireless power receiving device is not limited thereto, and the above-described configuration can be more effectively applied to a shape that is different from a simple three-dimensional shape and in which a plurality of three-dimensional shapes are combined, and the above-described operation and effect can be achieved.

<1> A wireless power receiving device, comprising a first power receiving coil and a second power receiving coil each configured to generate a power receiving current by being coupled to an external magnetic field; a load configured to be driven by power based on the power receiving current; a first power receiving resonance circuit configured to include the first power receiving coil and a first resonance capacitor; a second power receiving resonance circuit configured to include the second power receiving coil and a second resonance capacitor; a first rectifier circuit connected to the first power receiving resonance circuit and configured to rectify a resonance current of the first power receiving resonance circuit and supply power to the load; and a second rectifier circuit connected to the second power receiving resonance circuit and configured to rectify a resonance current of the second power receiving resonance circuit and supply power to the load. The first power receiving coil is a spiral coil of a planar shape. The second power receiving coil is a solenoid coil of a cylindrical shape. The first power receiving coil and the second power receiving coil are disposed in a state where a direction orthogonal to a plane of the spiral coil and an axis of the cylindrical shape of the solenoid coil are not parallel to each other. A current adding circuit is provided at a subsequent stage of each of the first rectifier circuit and the second rectifier circuit, adds a current rectified by the first rectifier circuit and a current rectified by the second rectifier circuit, and supplies power to the load.

<2> The wireless power receiving device according to <1>, wherein the current adding circuit constitutes an OR circuit.

<3> The wireless power receiving device according to <2>, wherein the OR circuit is constituted using a diode.

<4> The wireless power receiving device according to any one of <1> to <3>, wherein the plane of the spiral coil and the axis of the cylindrical shape of the solenoid coil are orthogonal to each other.

<5> The wireless power receiving device according to any one of <1> to <4>, wherein the spiral coil includes a wound linear conductor and a magnetic sheet disposed in parallel to the wound conductor.

<6> The wireless power receiving device according to any one of <1> to <5>, wherein the solenoid coil includes a spiral linear conductor and a magnetic core disposed inside the spiral linear conductor.

<7> The wireless power receiving device according to any one of <1> to <6>, wherein the external magnetic field has a frequency of 6.78 MHz or 13.56 MHz.

<8> The wireless power receiving device according to any one of <1> to <7>, wherein a first resonance frequency of the first power receiving resonance circuit and a second resonance frequency of the second power receiving resonance circuit are same.

<9> The wireless power receiving device according to any one of <1> to <8>, wherein the load includes a secondary battery and a charge/discharge control circuit that controls charging of the secondary battery.

<10> The wireless power receiving device according to <9>, wherein the secondary battery is a thin battery.

What is claimed is:

1. A wireless power receiving device, comprising:
a first power receiving coil and a second power receiving coil each configured to generate a power receiving current by being coupled to an external magnetic field, the first power receiving coil being a spiral coil of a planar shape, the second power receiving coil being a solenoid coil of a cylindrical shape, and the first power receiving coil and the second power receiving coil are in a state where a direction orthogonal to a plane of the spiral coil and an axis of the cylindrical shape of the solenoid coil are not parallel to each other;
a load configured to be driven by power based on the power receiving current;
a first power receiving resonance circuit configured to include the first power receiving coil and a first resonance capacitor;
a second power receiving resonance circuit configured to include the second power receiving coil and a second resonance capacitor;
a first rectifier circuit connected to the first power receiving resonance circuit and configured to rectify a resonance current of the first power receiving resonance circuit and supply power to the load;
a second rectifier circuit connected to the second power receiving resonance circuit and configured to rectify a resonance current of the second power receiving resonance circuit and supply power to the load; and
a current adding circuit at a subsequent stage of the first rectifier circuit and the second rectifier circuit, the current adding circuit being configured to add a current rectified by the first rectifier circuit and a current rectified by the second rectifier circuit, and to supply power to the load.

2. The wireless power receiving device according to claim 1, wherein
the current adding circuit includes an OR circuit.

3. The wireless power receiving device according to claim 2, wherein
the OR circuit includes a diode.

4. The wireless power receiving device according to claim 1, wherein
the plane of the spiral coil and the axis of the cylindrical shape of the solenoid coil are orthogonal to each other.

5. The wireless power receiving device according to claim 1, wherein
the spiral coil includes a wound linear conductor and a magnetic sheet in parallel to the wound linear conductor.

6. The wireless power receiving device according to claim 1, wherein
the solenoid coil includes a spiral linear conductor and a magnetic core inside the spiral linear conductor.

7. The wireless power receiving device according to claim 1, wherein
the external magnetic field has a frequency of 6.78 MHz or 13.56 MHz.

8. The wireless power receiving device according to claim 1, wherein
a first resonance frequency of the first power receiving resonance circuit and a second resonance frequency of the second power receiving resonance circuit are the same.

9. The wireless power receiving device according to claim 1, wherein
the load includes a secondary battery and a charge/discharge control circuit configured to control charging of the secondary battery.

10. The wireless power receiving device according to claim 9, wherein
the secondary battery is a thin battery.

11. The wireless power receiving device according to claim 2, wherein
the plane of the spiral coil and the axis of the cylindrical shape of the solenoid coil are orthogonal to each other.

12. The wireless power receiving device according to claim 3, wherein
the plane of the spiral coil and the axis of the cylindrical shape of the solenoid coil are orthogonal to each other.

13. The wireless power receiving device according to claim 2, wherein
the spiral coil includes a wound linear conductor and a magnetic sheet in parallel to the wound linear conductor.

14. The wireless power receiving device according to claim 3, wherein
the spiral coil includes a wound linear conductor and a magnetic sheet in parallel to the wound linear conductor.

15. The wireless power receiving device according to claim 2, wherein
the solenoid coil includes a spiral linear conductor and a magnetic core inside the spiral linear conductor.

16. The wireless power receiving device according to claim 3, wherein
the solenoid coil includes a spiral linear conductor and a magnetic core inside the spiral linear conductor.

17. The wireless power receiving device according to claim 2, wherein
the external magnetic field has a frequency of 6.78 MHz or 13.56 MHz.

18. The wireless power receiving device according to claim 3, wherein
the external magnetic field has a frequency of 6.78 MHz or 13.56 MHz.

19. The wireless power receiving device according to claim 2, wherein
a first resonance frequency of the first power receiving resonance circuit and a second resonance frequency of the second power receiving resonance circuit are the same.

20. The wireless power receiving device according to claim 2, wherein
the load includes a secondary battery and a charge/discharge control circuit configured to control charging of the secondary battery.
